(19) United States
(12) Patent Application Publication
(10) Pub. No.: US 2009/0213780 A1
(43) Pub. Date: Aug. 27, 2009

(54) Satellite Hub Based Adaptive Allocation Of Frequency Bands

(75) Inventor: Mark D. Dankberg, Encinitas, CA (US)

Correspondence Address: TOWNSEND AND TOWNSEND AND CREW LLP;VIASAT, INC (CLIENT #017018), TWO EMBARCADERO CENTER, EIGHTH FLOOR, CA, 94111, US

(73) Assignee: ViaSat, Inc., Carlsbad, CA (US)

(21) Appl. No.: 11/963,604

(22) Filed: Dec. 21, 2007

Related U.S. Application Data
(60) Provisional application No. 60/891,465, filed on Feb. 23, 2007.

(51) Int. Cl. H04B 7/185; H04J 3/22

(52) U.S. Cl. 370/316; 370/468

(57) ABSTRACT

A method and system for adaptive allocation of transmission bandwidth in a broadband satellite communication system having user terminals within a coverage area and outside a coverage area, such as an LDMS area. In a specific embodiment, the bandwidth is allocated at a central terminal (hub) to be used by both types of user terminals to communicate back to the hub terminal, wherein the spectrum and geographic coverage area of a primary user is excluded from use by user terminals located within the coverage area.

### CROSS-REFERENCES TO RELATED APPLICATIONS

SEE APPLICATION DATA SHEET

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

This invention relates to techniques for improving frequency allocation for communication satellites supporting consumer broadband services. Consumer broadband satellite services are emerging in North America with the introduction of star network services using Ka band satellites. First-generation satellite systems may provide multi-gigabit per second (Gbps) per satellite overall capacity. However, the design of such systems inherently limits the number of customers that may be adequately served. Moreover, the capacity is split across numerous coverage areas so that the bandwidth available to each subscriber-user is further limited.

There have been strong advances in communications and processing technology that can be applied to satellite-based consumer broadband services. This technology, in conjunction with selected innovative system and component design, may be harnessed to produce a novel satellite communications system to address this demand.

### SUMMARY OF THE INVENTION

According to the invention, a method and system are provided for adaptive allocation of transmission bandwidth in a broadband satellite communication system having user terminals outside a separate wireless communication service coverage area, such as a Local Multipoint Distribution System (LDMS) area. In a specific embodiment, the bandwidth is allocated at a central terminal (hub) to be used by both types of user terminals to communicate back to the hub terminal, wherein the spectrum and geographic coverage area of a primary user is excluded from use by user terminals located within the corresponding coverage area. The coverage of the satellite communication system can be larger than the spectrum usage area of licensed services, such as that of the LMDS architecture. For user terminals outside of the licensed service area, the hub allocates bandwidth within the LMDS spectrum and/or outside the LMDS spectrum. User terminals inside the licensed area are allocated outside the LMDS spectrum only. In some embodiments, terminals may be mobile, in which case their location is monitored to adaptively adjust their frequency allocation based on their current location.

The invention will be better understood by reference to the following detailed description in connection with the accompanying drawings.

### BRIEF DESCRIPTION OF THE DRAWINGS

FIG. 1 is a block diagram of a satellite communication system with partial LMDS spectral usage.

FIG. 2 is an example of a frequency plan according to the invention.

FIG. 3 is a flow chart of a method according to the invention.

### DETAILED DESCRIPTION OF THE INVENTION

According to the invention, in a satellite communication system, bandwidth is allocated at a central (hub) terminal to be used by user terminals (UTs) to communicate back to the hub terminal with adaptive use of satellite uplink bands. One example of an implementation of such a technique allows flexible use of frequency channels by a subscriber terminal that is a secondary spectrum license holder. (The right of a secondary spectrum license holder to transmit on a specified frequency band is subordinate to a primary spectrum license holder such that the primary spectrum license holder is able to transmit signals on the frequency band whenever it chooses without regard for other users, whereas a secondary spectrum license holder is only authorized to transmit on the specified frequency band if the primary spectrum license holder is not transmitting on the specified band.) Adaptive use of satellite uplink bands as described in various embodiments of the present invention may be utilized by a system which is a secondary spectrum holder, in order to ensure that when a primary license holder's signal is active in the area of a user terminal, re-assignment of the user terminal transmit frequency channel can be performed to move satellite user uplink transmission to a different frequency so as to not interfere with the primary spectrum license holder.

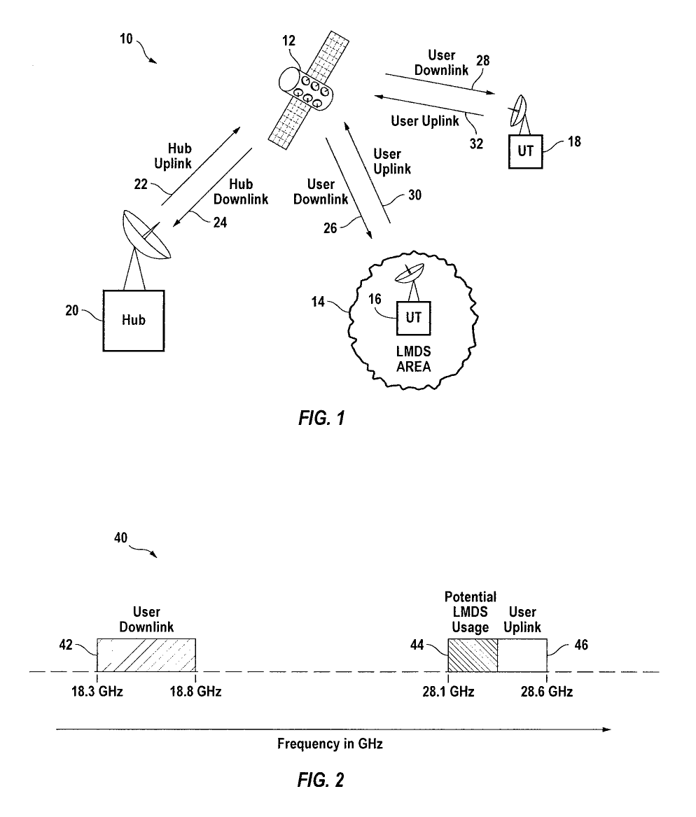

FIG. 1 is a depiction of a satellite communication system 10 built around a multiple link-capable satellite 12 with some terminals within range of a primary spectrum license holder (in this example, in a LMDS area 14). One satellite terminal UT 16 is shown within the LMDS area 14, but in general many terminals would be in such an area. Outside the LMDS area 14, another example user terminal UT 18 is shown, although in general many more terminals would be supported in such a system. Multiple LMDS areas could be found within range of a typical wide range satellite 12. For clarity, only one example LMDS area is shown.

A ground-based hub 20 is configured to communicate via a hub uplink 22 and hub downlink 24 to the satellite 12 acting as a relay station. Hub uplink signals originate at the hub 20 and are beamed to the satellite 12, where they are processed (typically frequency translated, amplified, etc.) and relayed via selected user downlinks 26, 28 to the user terminals 16, 18. In typical systems, a single, high-rate signal is transmitted via the downlinks 26, 28 to multiple terminals 16, 18, which each demodulate and extract the information directed to and intended for them. This high-rate signal originating on the hub uplink 22 also generally contains a control stream which the hub 20 uses to direct the user terminals 16, 18 to transmit signals over any shared return bandwidth via the user uplink or uplinks 30, 32 to the satellite 12. The user-terminal-originating signals on the user uplinks 30, 32 are again processed at the satellite and sent to the hub 20 on the hub downlink 24.

An example frequency plan 40 for the user uplinks 28 according to the invention is depicted in FIG. 2. Here, the user downlink 26 occupies a range 42 consisting of a contiguous span of frequency from 18.3 GHz to 18.8 GHz. One high-rate signal at 1 GBps could occupy this frequency range and be directed to all the user terminals in the total coverage area. The user uplinks 30, 32 are generally narrow band (for example they may be frequency division multiplexed) and fit somewhere within the user uplink bandwidth (28.1-28.6 GHz) as directed by the hub 20. The user uplink bandwidth may be divided between a potential LDMS usage spectrum 44 and an open spectrum 46.

In this example, however, some of the user terminals, i.e., UT 16, are disposed in an LDMS area in which the lower half of this spectrum 44 is dedicated to a LMDS primary license holder (not shown). The individual user uplinks 30, 32 in this example are assumed to occupy much less bandwidth than the upper spectrum band which is available to all user terminals.

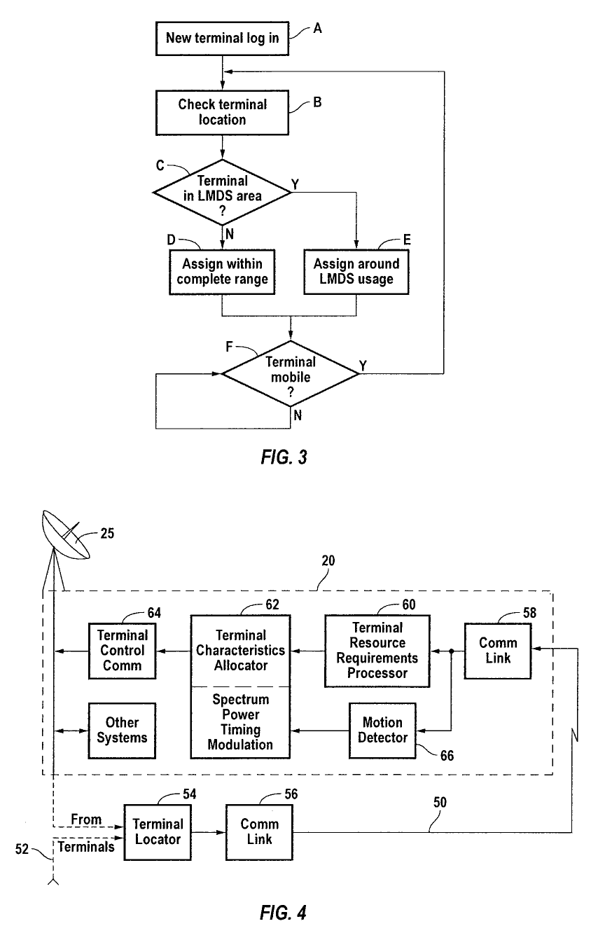

FIG. 3 depicts a flow diagram of an exemplary implementation of a communication protocol in accordance with the subject invention. The process starts when a terminal logs into the satellite communication system (Step A). It is assumed that either the user terminal can determine if it is in an LMDS area 14 and thus place an initial log-in request in an available frequency, or that terminals use a frequency band that is known a priori to be in a band outside the range of any primary license holders.

The terminal's absolute location is then determined (Step B). Location can be determined many ways. For example, in a fixed terminal system, the subscriber may be identified by zip code upon system installation. Other techniques, such as GPS coordinates, may be employed at the user terminal and can report the terminal's location using the same communication technique used for system overhead and control communication between user terminals and the hub.

Once the user's location is determined and communicated to the hub 20, the hub 20 can then determine if the user terminal 16 is within an area 14 corresponding to the range of a primary spectrum license holder (Step C). This can be done in a variety of ways. Following the example listed above in which the user is identified by the zip code of the installation, a table can be maintained at the hub 20 listing all the zip codes known to be impacted by primary spectrum licensed usage. For systems that track user terminals through the use of GPS derived coordinates, distance metrics can be determined to gauge whether a terminal is within the area 14 dedicated to any primary spectrum license holders.

If the subject terminal 18 is found to be outside the LMDS area 14 of any primary spectrum license holder, the following step is to allow the user terminal to be issued spectrum allocations from the entire range of possible frequencies available to the satellite communication system (Step D).

If, however, the terminal 16 is found to be inside the LMDS area 14 of a primary spectrum license holder, the user terminal 16 is only allowed by the hub 20 to be issued spectrum allocations from the upper spectrum 46, which are frequencies that do not overlap with that of the identified primary spectrum license holder. (Step E)

The hub 20 is the central repository of information relative to the satellite communication system. It will know, for example, the ratio of the number of terminals in impacted areas to the number of terminals in non-impacted areas, and it will therefore be configured to allocate the frequency to each user uplink 30, 32 accordingly. For a simple example, assume the case specifically illustrated in FIGS. 1 and 2. In this case, there is exactly one range of frequencies impacted by exactly one type of license holder. (Of course, there may be many separate areas in which the spectrum is used locally, although only one such area is depicted in FIG. 1.) The spectral range of impacted frequency is exactly one half of the total frequency range.

If exactly half of the required frequency range needed by all user terminals 16, 18 is from user terminals 16 located in impacted area 14, while half the required spectrum is needed by terminals 18 outside impacted areas, the hub 20 may implement a strategy under which terminals 16 from impacted area 14 use frequencies outside that of the spectrum of the impacted primary license holder, while the non-impacted terminals 18 use spectrum 44 that is used by the primary license holders, since these terminals 18, being outside the LDMS area 14, will not interfere with the primary use of the LDMS spectrum 44). Noteworthy is that the amount of spectrum required by any individual user terminal need not be equally allocated so the hub is operative to apportion spectrum according to system needs. The hub 20 is charged with knowing requirements and allocating user terminal spectrum, as well as other characteristics of the user terminal transmissions, such as transmit time, modulation and coding, power level, etc., and so is further operative to assign these characteristics in accordance with system-wide considerations.

If more spectrum is required by non-impacted terminals 18 than is required by impacted terminals 16, the hub 20 may also allocate frequency outside the LDMS area 14 of the primary license holders to non-impacted terminals 18.

Finally, a determination is made as to whether the subject terminal is mobile. Step F) If so, the terminal's location is checked again (Step B), and the allocation process is repeated.

Referring to FIG. 4, the process herein described is typically implemented in the hub 20 although some of the components may be distributed and communicate with the hub 20 through available communication links, either through the satellite 12 (FIG. 1) to the ground terminal 25 or through a terrestrial channel 50, with some of the information needed by the components being received via communication lines 52 directly from the terminals. Whatever the configuration, there is a terminal locator 54 that communicates via internal or external communication links 56, 58 to the hub 20. There, a terminal resource requirements processor 60 determines the communication needs and requirements of each terminal, taking into account capabilities, and reports those requirements to a terminal characteristics allocator (TCA) 62. A motion detector 66 decides which of the terminals are in motion and reports to the TCA 62. The TCA 62 specifies and allocates spectrum, as well as for example power, time slots and modulation for each terminal under its control. A terminal control communications module 64 takes those allocations and communicates them via the ground terminal 25 to each of the impacted terminals. The terminal processor 60, the motion detector 66 and the TCA 62 implement each of their specific functions by means of software elements or their equivalent functions, as hereinabove outlined.

The invention has been explained with reference to specific embodiments. Other embodiments will be evident to those of skill in the art. It is therefore not intended that the invention be limited, except as indicated by the appended claims.

What is claimed is:

1. In a broadband satellite communication system having a hub and having user terminals within a coverage area and outside a coverage area, the coverage area having at least a portion of spectrum potentially used by a primary user, a method for adaptive allocation of transmission bandwidth, comprising:
a) determining terminal location of each terminal;
b) reporting terminal location of each terminal to the hub;
c) causing the hub to allocate frequency spectrum for user terminal uplink back to the hub, wherein the spectrum and geographic coverage area of the primary user is excluded from use by first user terminals located within the coverage area; and
d) causing the hub to communicate information on frequency spectrum allocation for each said first user terminal to each said first user terminal and for each said second user terminal to each said second user terminal.

2. The method according to claim 1 further including:
e) determining if said first and second user terminals are mobile and for each determination, and repeating steps a) through d).

3. The method according to claim 1, wherein said step c) further includes:
c1) determining whether spectrum requirements of said first user terminals within the primary user geographic area can be allocated equally with said second user terminals outside said primary user geographic area; and
c2) assigning frequency spectrum of said primary user to said second user terminal.

4. The method according to claim 3 wherein said step c) further includes
c3) assigning frequency spectrum to said first user terminal outside said frequency spectrum of said primary user.

5. The method according to claim 4 wherein said frequency spectrum assigning step c3) includes:
assigning spectrum to all user terminals individually according to system considerations.

6. The method according to claim 4 wherein step c) further includes
allocating transmit time, power level, modulation and coding to said first user terminal.

7. The method according to claim 1 wherein said coverage area is a Local Multipoint Distribution System (LDMS) area.

8. A broadband satellite communication system having a hub and having user terminals within a coverage area and outside a coverage area, the coverage area having at least a portion of spectrum potentially used by a primary user, a subsystem for adaptive allocation of transmission bandwidth, comprising:
a) a terminal locator for determining terminal location of each terminal;
b) a communicator for reporting terminal location of each terminal to the hub;
c) a characteristics allocator for causing the hub to allocate frequency spectrum for user terminal uplink back to the hub, wherein the spectrum and geographic coverage area of the primary user is excluded from use by first user terminals located within the coverage area; and
d) a terminal command controller for causing the hub to communicate information on frequency spectrum allocation for each said first user terminal to each said first user terminal and for each said second user terminal to each said second user terminal.

9. The system according to claim 8 further including:
e) a motion detector for determining if said first and second user terminals are mobile. d).

10. The system according to claim 8, wherein said characteristics allocator c) further includes:
c1) a software element for determining whether spectrum requirements of said first user terminals within the primary user geographic area can be allocated equally with said second user terminals outside said primary user geographic area; and
c2) a software element for assigning frequency spectrum of said primary user to said second user terminal.

11. The system according to claim 10 wherein said characteristics allocator c) further includes c3) a software element for assigning frequency spectrum to said first user terminal outside said frequency spectrum of said primary user.

12. The system according to claim 11 wherein said frequency spectrum assigning element c3) includes:
a software element for assigning spectrum to all user terminals individually according to system considerations.

13. The system according to claim 11 wherein characteristics allocator c) further includes
software elements for allocating transmit time, power level, modulation and coding to said first user terminal.

14. The system according to claim 8 wherein said coverage area is a Local Multipoint Distribution System (LDMS) area.
